(19) United States
(12) Patent Application Publication
(10) Pub. No.: US 2005/0220694 A1
(43) Pub. Date: Oct. 6, 2005

(54) Method for producing nitrides

(76) Inventors: Holger Winkler, Darmstadt (DE); Isabel Kinski, Darmstadt (DE); Ralf Riedel, Babenhausen (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/512,554

(22) PCT Filed: Apr. 23, 2003
(86) PCT No.: PCT/EP03/04195

§ 371 Date: Oct. 25, 2004

(30) Foreign Application Priority Data
Apr. 24, 2002 (DE) 102 18 409.7

(51) Int. Cl. C01B 21/00

(52) U.S. Cl. 423/409

(57) ABSTRACT

The present invention relates to a process for the preparation of nitrides of the formula Ga₁₋ₓInₓN, where 0.01≦x≦1, in which one or more compounds of the general formula, M(NR₂)₃, where all R, independently of one another, are H, linear or branched —C₁₋₈-alkyl or —SiR^{x}₂, where R^{x} is linear or branched —C₁₋₈-alkyl, and M is Ga, In or Ga₁₋ₓInₓ, are reacted with ammonia, where the one or more compounds M(NR₂)₃ are selected in such a way that the ratio 1−x Ga to x In also applies in these compounds.

The present invention relates to a process for the preparation of nitrides of the formula Ga₁₋ₓInₓN, where 0.01≦x≦1, and to the use of the process end products.

InN and GaN are semiconductors having a direct band gap of 1.9 eV (InN) or 3.4 eV (GaN) in the hexagonal (wurtzite) crystal structure. Both compounds exhibit efficient (photo)luminescence corresponding to this direct band gap (after irradiation with light of sufficient energy h*ν>E_{gap}).

The production of thin layers of mixed indium nitride and gallium nitride is known from various publications. For example, the publications K. Osamura, S. Naka, Y. Murakami; J. Appl. Phys. Vol. 46(8), 1975; pp. 3432-3437 discloses that crystalline layers can be deposited by means of the electron-beam plasma technique from mixtures of high-purity gallium and indium by reaction with high-purity N₂. It is furthermore known from the publications that the mixed crystals and also the binary nitrides crystallise in the wurtzite structure. A linear relationship exists between the lattice constants of the mixed crystals and the compositions of the mixed crystals. It was likewise shown therein that the energy of the band gap decreases continuously with increasing proportion of indium in the mixed crystals. It was correspondingly claimed that the luminescence colour can be adjusted from blue-violet to red in this mixed-crystal series via the composition of the mixed crystals.

GaN and In(x)Ga(y)N layers are frequently also produced by MOCVD (metal-organic chemical vapour deposition) processes (cf. H. Morkoc, “Nitride Semiconductors and Devices”, Springer Verlag, Berlin, Heidelberg, 1999).

In general, all known thin-layer processes are very complex. They require very high temperatures, a large excess of the starting materials (for example GaEt₃, or InEt₃ is reacted with an approximately 1000-fold molar excess of NH₃ in the MOCVD process). The growth of uniform layers is also problematic. There is no substrate which withstands the high temperatures necessary (about 1000° C.) and at the same time has corresponding lattice parameters. Homoepitactic deposition is thus not possible. Certain growth modes via a so-called buffer layer enable heteroepitactic growth, with considerable effort, on substrates which have lattice parameters differing from the nitride. However, lattice defects easily form here.

Nanocrystalline powders are not accessible using the processes described.

However, for utilisation of the luminescence effect of the hexagonally crystallising mixed-crystal nitrides in many industrial applications, a preparation process would be necessary which allows relatively large amounts of pulverulent nitrides of the formula Ga₁₋ₓInₓN in pure form to be prepared.

There is therefore a demand for a preparation process for particulate mixed-crystal nitrides of the formula Ga₁₋ₓInₓN which can be employed industrially.

Surprisingly, it has now been found that InₓGa₁₋ₓN can be obtained by means of solid-state pyrolysis of suitable precursors in an ammonia atmosphere.

A first subject-matter of the present invention is therefore a process for the preparation of nitrides of the formula Ga₁₋ₓInₓN, where 0.01≦x≦1, which is characterised in that one or more compounds of the general formula M(NR₂)₃, where all R, independently of one another, are H, linear or branched —C₁₋₈-alkyl or —SiR^{x}₂, where R^{x} is linear or branched —C₁₋₈-alkyl, and M is Ga, In or Ga₁₋ₓInₓ, are reacted with ammonia, where the one or more compounds M(NR₂)₃ are selected in such a way that the ratio 1−x Ga to x in also applies in these compounds.

The nitrides of the formula Ga₁₋ₓInₓN, where 0.01≦x≦1, obtainable in this way are preferably highly crystalline powders which, for x<1, are preferably obtained in the form of phase-pure mixed crystals. Mixed crystals in which x≦0.99, preferably x≦0.90 or 0.05≦x, preferably 0.10≦x, are preferably obtained. In another, likewise preferred variant of the process according to the invention, pure InN is prepared.

In particular for the applications described, it is necessary that the nitrides are in their hexagonal modification (wurtzite structure). While the known deposition processes also frequently supply the cubic zinc-blende form, the process according to the invention enables the hexagonal modification of the nitrides to be obtained in phase-pure form.

The nitrides according to the invention may contain impurities. In particular with respect to optical and electronic applications, however, it is preferred if the proportion of impurities is as low as possible. In particular, it is preferred if the proportion of impurities is less than 1% by weight.

The impurities which occur are primarily oxides and imides or —O— or —NH— functions as flaws in the nitride crystal lattice. In order to keep these impurities as low as possible, it is necessary to exclude oxygen and moisture during the preparation of the precursors or the nitrides. Corresponding working techniques which enable this through the use of protective gases, preferably argon, and purification of the reagents and auxiliaries employed are familiar to the person skilled in the art.

The precursors employed are compounds M(NR₂)₃, where all R, independently of one another, are H, linear or branched —C₁₋₈-alkyl or —SiR^{x}₂, where R^{x} is linear or branched —C₁₋₈-alkyl, and M is Ga, In or Ga₁₋ₓInₓ. Preferred radicals R here are H, methyl, ethyl, isopropyl, tertiary-butyl and trimethylsilyl. Particularly preferred compounds M(NR₂)₃ are selected from the compounds M(NH^{t}Bu)₃, M(N(CH₃)₂)₃, M(N(C₂H₅)₂)₃ and M(N(Si(CH₃)₃)₂)₃. In accordance with the invention, the compounds M(NR₂)₃ can be defined, crystalline compounds. Examples of defined compounds of this type are In(NH^{t}Bu)₃, which, according to the dissertation Th. Grabowy “Synthese und Struktur neuer Gallium- und Indium-Stickstoff-Verbindungen” [Synthesis and Structure of Novel Gallium- and Indium-Nitrogen Compounds], University of Halle, 2001, crystallises in the form of a tetrameric Cuban cage, and Ga(NH^{t}Bu)₃ and [Ga(NMe₂)₃]₂, which form dimers containing a four-membered ring in which gallium is bonded to gallium via nitrogen (cf. Nöth et al. Z. Naturforsch. 1975, 30b, 681).

In particular if M in M(NR₂)₃ is InₓGa₁₋ₓ where x<1, however, these “compounds” can, in accordance with the invention, also be poorly defined mixtures of reaction products of the halide mixtures or mixed crystals of gallium and indium with corresponding amides.

The precursors are preferably prepared in a preceding reaction step by reaction of corresponding indium and gallium halides with compounds of the general formula LiNR₂ (also referred to as lithium amide below), where all R, independently of one another, are H, linear or branched —C₁₋₈-alkyl or —SiR^{x}₂, where R^{x} is linear or branched —C₁₋₈-alkyl. The indium and gallium halides are preferably chlorides, bromides, iodides or mixtures thereof, particularly preferably chlorides. The preparation of the precursors mentioned above by way of example is known from the cited literature.

The reaction of the halide(s) with the lithium amide is preferably carried out in an inert solvent, with the lithium amide being slowly added to a solution or suspension of the halides. Suitable solvents for this reaction are conventional aprotic solvents. For example, use can be made of diethyl ether, tetrahydrofuran, benzene, toluene, acetonitrile, dimethoxyethane, dimethylformamide, dimethyl sulfoxide and N-methylpyrrolidone.

The reaction product can then be separated off from the by-product lithium halide either by washing or by extraction with a suitable solvent.

If M in M(NR₂)₃ is InₓGa₁₋ₓ where x<1, the halides are preferably employed for the reaction with the lithium amide in the molar ratio x In to 1−x Ga, which should be set in the precursor and also in the resultant nitride. In this case, the nitride is prepared using only one compound M(NR₂)₃, where all R have the above-mentioned meaning and M is Ga₁₋ₓInₓ, and the compound M(NR₂)₃ is preferably prepared by reaction of a mixture of 1−x parts of gallium halide and x parts of indium halide with the corresponding lithium amide.

In another preferred variant of the process according to the invention, at least one compound Ga(NR₂)₃ and at least one compound In(NR₂)₃ is employed, where all R, independently of one another, have the above-mentioned meaning. In this case, the gallium and indium amides are prepared separately and then mixed in accordance with the desired gallium to indium ratio before the reaction with ammonia.

The one or more compounds of the general formula M(NR₂)₃ are, in accordance with the invention, reacted with ammonia. The reaction here can be carried out in an ammonia atmosphere or in a stream of ammonia. The reaction with ammonia is preferably carried out essentially at a temperature from the range from 200° C. to 1000° C. Essentially here means that it is also preferred in accordance with the invention if the reaction with ammonia is begun at room temperature and continued at elevated temperature. In practice, this means that the precursors in this preferred variant of the invention are heated in a stream of ammonia. However, it is assumed that the actual formation of the nitrides only takes place at the elevated temperature. The reaction preferably proceeds at temperatures in the range from 400° C. to 600° C. and is particularly preferably carried out at a temperature from the range from 450° C. to 550° C. Particularly good results have been obtained at temperatures of about 500° C. In general, it can be assumed here that higher temperatures allow shorter reaction times and lower temperatures make longer reaction durations necessary. If phase-pure, highly crystalline products are desired, however, it has been found that it is advantageous to work at temperatures in the range from 400° C. to 600° C., since it has been observed in individual cases that elemental indium forms as impurity at reaction temperatures above 600° C. and reaction times of 2 hours or more.

For use as fluorescence marker, the InₓGa₁₋ₓN crystallites according to the invention should have a narrow-band and stable photoluminescence which can be set reproducibly. This requires highly crystalline, phase-pure mixed crystals, which are also in the form of homogeneous mixed crystals of precise composition in the crystal domains. It has been found that the nitrides which can be prepared in accordance with the invention meet these requirements. A further subject-matter of the present invention is therefore the use of the process end products according to the invention as fluorescence markers.

A further application of the process end products according to the invention consists in the use as frequency converters in light-emitting diodes (LEDs). The mixed crystals prepared in accordance with the invention are integrated here into the lamp of an intensely luminous LED. The electroluminescent, short-wave light radiation of the LED excites the mixed crystals to photoluminescence. The light then emitted by the LED is composed additively of the electroluminescence light of the LED and the photoluminescence light of the mixed crystal. Through a suitable arrangement of different mixed crystals of the formula InₓGa₁₋ₓN having different values for x and thus different band gaps in the lamp of the LED, it is thus possible to generate multiband luminescence using an LED of this type. A further subject-matter of the present invention is therefore a light-emitting diode which contains at least one process end product according to the invention.

In particular, polymeric emitters (“long” molecules in organic LEDs (=OLEDs) exhibit broad electroluminescence bands. This has an adverse effect on the spectral purity of the perceived colour. In particular in the case of “red” OLEDs, a large fraction of the intensity is in the infrared region. These OLEDs thus have only low intensity and are often perceived by the human eye as orange instead of red. If the process end products according to the invention are combined with the OLEDs, the electroluminescent polymer in a radiation-less transition excites the mixed-crystal nitride to photoluminescence. The narrow-band luminescence of the nitride is perceived. In addition, the direct band gap of the semiconductor enables the intensity of the OLED to be increased.

The following example serve to illustrate the present invention and do not restrict the subject-matter of the invention. In addition, the invention can be carried out in the manner described throughout the range claimed.

### EXAMPLES

All reactions described below are, unless indicated otherwise, carried out with exclusion of air and moisture (argon atmosphere). All reagents are employed either directly in appropriate purity or are purified and dried by standard methods (for example in accordance with “Handbuch der präparativen anorganischen Chemie” [Handbook of Preparative Inorganic Chemistry] Georg Brauer (editor) 3rd Edition, F. Enke Verlag Stuttgart 1975 or “Organikum” [Practical Organic Chemistry], 21 st Edition, Wiley-VCH Weinheim, 2001).

Abbreviations:

Me methyl
^{t}Bu tertiary-butyl
THF tetrahydrofuran

### Example 1a

### Preparation of In(NH^{t}Bu)₃

6 g of InCl₃ are mixed with 150 ml of cooled tetrahydrofuran (THF) in a flask at −80° C. The mixture is stirred for some time, and LiNH^{t}Bu (3 mol per mole of InCl₃; dissolved in 200 ml of THF) is subsequently added dropwise with constant stirring and cooling. The reaction vessel is subsequently slowly warmed and stirred for 40 hours. The resultant solution is evaporated to dryness, and the resultant powder is treated with toluene in a Soxhlet extractor for 24 hours at 135° C. The resultant solution is concentrated considerably and taken up in n-hexane. At −20° C., the crystals of In(NH^{t}Bu)₃ precipitate. The crystals are decanted off from the solution and dried under reduced pressure.

### Example 1b

In(N(CH₃)₂)₃ is obtained analogously to Example 1a from InCl₃ and LiN(CH₃)₂. Ga(NH^{t}Bu)₃ and Ga(NMe₂)₃ are likewise obtained analogously to Example 1a from GaCl₃. Since these compounds are more soluble in toluene, the extraction here can be replaced by simple dissolution and filtering-off.

### Example 2

### Preparation of InₓGa₁₋ₓN by Ammonolysis of the Precursors from Example 1

The two precursors In(N(CH₃)₂)₃ and Ga(NMe₂)₃ are mixed intimately with one another in the desired molar ratio x In to 1−x Ga and subsequently reacted in a stream of ammonia in a Schlenk tube with fill connectors. Firstly, ammonia is passed over the mixture for 10 hours at room temperature, and the mixture is subsequently warmed to 500° C. (heating rate: 100° C./h), and the temperature is maintained for 2 hours. After cooling in a stream of argon, finely crystalline InₓGa₁₋ₓN is obtained.

The reaction can also be carried out analogously starting from the other precursors. In general, x In(NR₂)₃ are reacted with 1−x Ga(NR₂)₃, where all R may be identical or different.

### Example 3

### Preparation of InₓGa₁₋ₓ(NMe₂)₃

6 g of a mixture of InCl₃ and GaCl₃ in the molar ratio x: 1−x are mixed with 150 ml of cooled tetrahydrofuran (THF) in a flask at −80° C. The mixture is stirred for some time, and LiNMe₂ (3 mol per mole of MCl₃; dissolved in 200 ml of THF) is subsequently added dropwise with constant stirring and cooling. The reaction vessel is subsequently slowly warmed and stirred under reflux for 40 hours. The resultant solution is evaporated to dryness, and the resultant powder is treated with toluene in a Soxhlet extractor for 24 hours at 135° C. The resultant solution is concentrated considerably and taken up in n-hexane. At −20° C., the crystals of InₓGa₁₋ₓ(NMe₂)₃ precipitate. The solid is decanted off from the solution and dried under reduced pressure.

The reaction can also be carried out analogously with other compounds LiNR₂ for example LiNH^{t}Bu.

### Example 4

### Preparation of InₓGa₁₋ₓN by Ammonolysis of the Precursors from Example 3

The product from Example 3 is reacted in a stream of ammonia in a flow tube. Firstly, ammonia is passed over the mixture for 10 hours at room temperature, the mixture is subsequently warmed to 500° C. (heating rate: 100° C./h), and the temperature is maintained for 2 hours. After cooling in a stream of argon, finely crystalline InₓGa₁₋ₓN is obtained.

1. Process for the preparation of nitrides of the formula Ga₁₋ₓInₓN, where 0.01≦x≦1, characterised in that one or more compounds of the general formula M(NR₂)₃, where all R, independently of one another, are H, linear or branched —C₁₋₈-alkyl or —SiR^{x}₂, where R^{x} is linear or branched —C₁₋₈-alkyl, and
M is Ga, In or Ga₁₋ₓInₓ,
are reacted with ammonia, where the one or more compounds M(NR₂)₃ are selected in such a way that the ratio 1−x Ga to x In also applies in these compounds.

2. Process according to claim 1, characterised in that, in a preceding reaction step, indium halides and gallium halides are reacted with compounds of the general formula LiNR₂, where all R, independently of one another, are H, linear or branched —C₁₋₈-alkyl or —SiR^{x}₂ where R^{x} is linear or branched —C₁₋₈-alkyl, to give the compounds M(NR₂)₃, where M has the above-mentioned meaning.

3. Process according to claim 2, characterised in that the indium and gallium halides are chlorides, bromides, iodides or mixtures thereof, preferably chlorides, where the halides are preferably employed in the molar ratio x In to 1−x Ga.

4. Process according to claim 1, characterised in that the reaction with ammonia is essentially carried out at a temperature from the range from 200° C. to 1000° C., preferably in the range from 400° C. to 600° C. and particularly preferably at a temperature from the range from 450° C. to 550° C.

5. Process according to claim 1, characterised in that the reaction with ammonia is begun at room temperature and continued at elevated temperature.

6. Process according to claim 1, characterised in that the compound M(NR₂)₃ is selected from the compounds M(NH^{t}Bu)₃, M(N(CH₃)₂)₃, M(N(C₂H₅)₂)₃ and M(N(Si(CH₃)₃)₂)₃.

7. Process according to claim 1, characterised in that one compound M(NR₂)₃ is employed, where all R have the above-mentioned meaning and M is Ga₁₋ₓInₓ, where the compound M(NR₂)₃ is preferably prepared by reaction of a mixture of 1−x parts of gallium halide and x parts of indium halide according to claim 2.

8. Process according to claim 1, charaterised in that at least one compound Ga(NR₂)₃ and at least one compound In(NR₂)₃ are employed, where all R, independently of one another, have the above-mentioned meaning.

9. Use of the products of a process according to claim 1 as fluorescence markers.

10. Light-emitting diode which contains at least one nitride of the formula Ga₁₋ₓInₓN, where 0.01≦x≦1, prepared by a process according to claim 1.
